(19) United States
(12) Patent Application Publication
(10) Pub. No.: US 2021/0150871 A1
(43) Pub. Date: May 20, 2021

(54) Tracking Bandage Assembly

(71) Applicant: Ulinda Bynum, Dothan, AL (US)

(72) Inventor: Ulinda Bynum, Dothan, AL (US)

(21) Appl. No.: 16/684,228

(22) Filed: Nov. 14, 2019

(51) Int. Cl. G08B 21/02; H04B 1/3827; G08B 25/01

(52) U.S. Cl. CPC G08B 21/0269; H04B 1/385; G08B 21/0291; G08B 21/028; G08B 21/0288; G08B 25/016

(57) ABSTRACT

A tracking bandage assembly includes a bandage that is securable to a user to present the ornamental appearance of a dressing on a wound. A pad is coupled to the bandage and the pad has blood indicia thereon to present the ornamental appearance of having dressed a wound. A tracking unit is integrated into the bandage. The tracking unit is in electrical communication with a global positioning system (gps) to establish the physical location of the bandage. The tracking unit is in electrical communication with an extrinsic communication network. In this way the transceiver can notify emergency responders of the physical location of the bandage thereby facilitating the user to be located in an emergency.

### CROSS-REFERENCE TO RELATED APPLICATIONS

Not Applicable

### Statement Regarding Federally Sponsored Research or Development

Not Applicable

### The Names of the Parties to a Joint Research Agreement

Not Applicable

### Incorporation-by-Reference of Material Submitted on a Compact Disc or as a Text File via the Office Electronic Filing System

Not Applicable

### Statement Regarding Prior Disclosures by the Inventor or Joint Inventor

Not Applicable

### BACKGROUND OF THE INVENTION

### (1) Field of the Invention

The disclosure relates to tracking devices and more particularly pertains to a new tracking device for discretely tracking the physical location of a user.

### (2) Description of Related Art including information disclosed under 37 CFR 1.97 and 1.98.

The prior art relates to tracking devices.

### BRIEF SUMMARY OF THE INVENTION

An embodiment of the disclosure meets the needs presented above by generally comprising a bandage that can be secure to a user to present the ornamental appearance of a dressing on a wound. A pad is coupled to the bandage and the pad has blood indicia thereon to present the ornamental appearance of having dressed a wound. A tracking unit is integrated into the bandage. The tracking unit is in electrical communication with a global positioning system (gps) to establish the physical location of the bandage. The tracking unit is in electrical communication with an extrinsic communication network. In this way the transceiver can notify emergency responders of the physical location of the bandage thereby facilitating the user to be located in an emergency.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a tracking bandage assembly according to an embodiment of the disclosure.

FIG. 2 is a bottom view of an embodiment of the disclosure.

FIG. 3 is a front phantom view of an embodiment of the disclosure.

FIG. 4 is a perspective in-use view of an embodiment of the disclosure.

FIG. 5 is a top view of an embodiment of the disclosure showing a bandage with a circular shape.

FIG. 6 is a front phantom view of an embodiment of the disclosure showing a bandage with a circular shape.

FIG. 7 is a side perspective in-use view of an embodiment of the disclosure.

FIG. 8 is a perspective in-use view of an embodiment of the disclosure.

FIG. 9 is a schematic view of an embodiment of the disclosure.

### DETAILED DESCRIPTION OF THE INVENTION

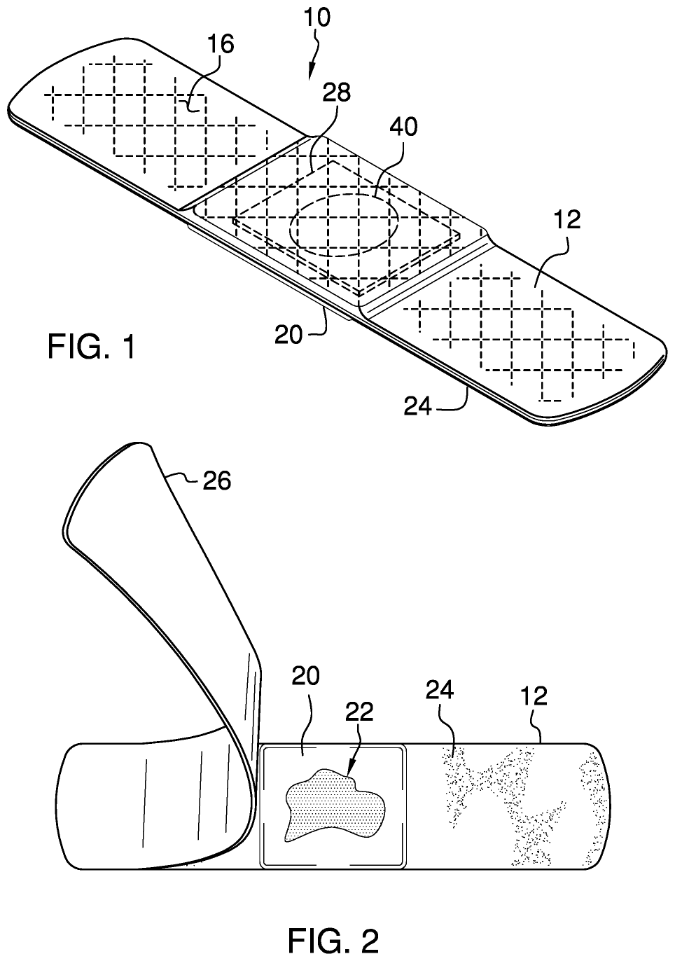

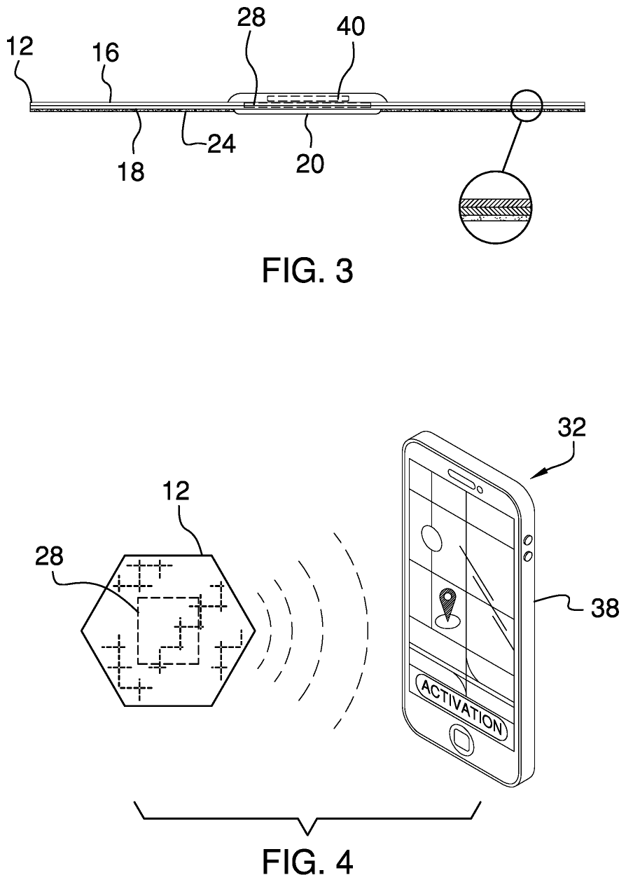

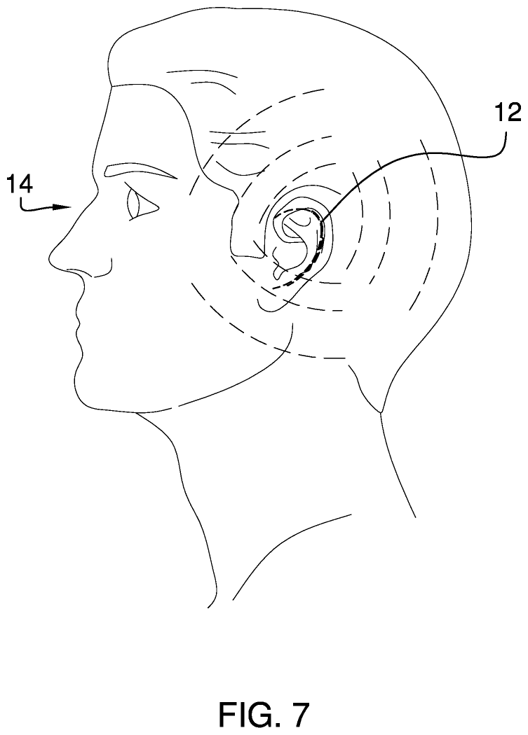

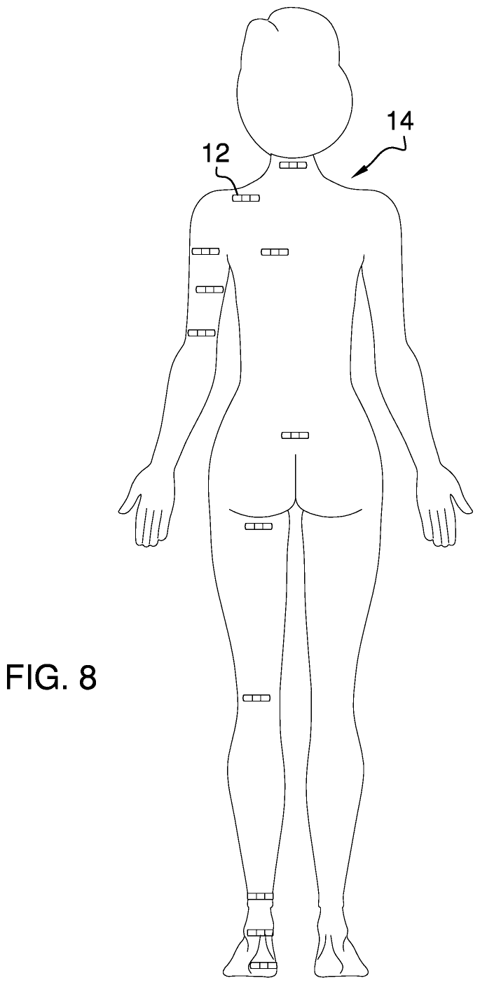

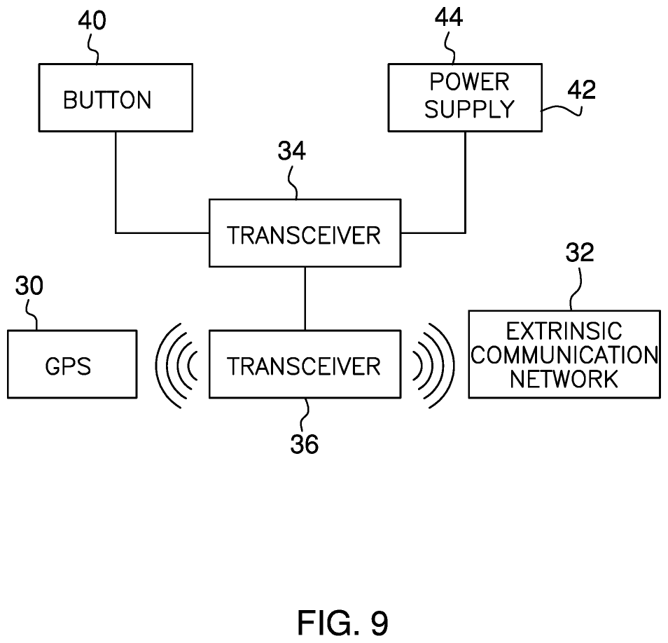

With reference now to the drawings, and in particular to FIGS. 1 through 9 thereof, a new tracking device embodying the principles and concepts of an embodiment of the disclosure and generally designated by the reference numeral 10 will be described.

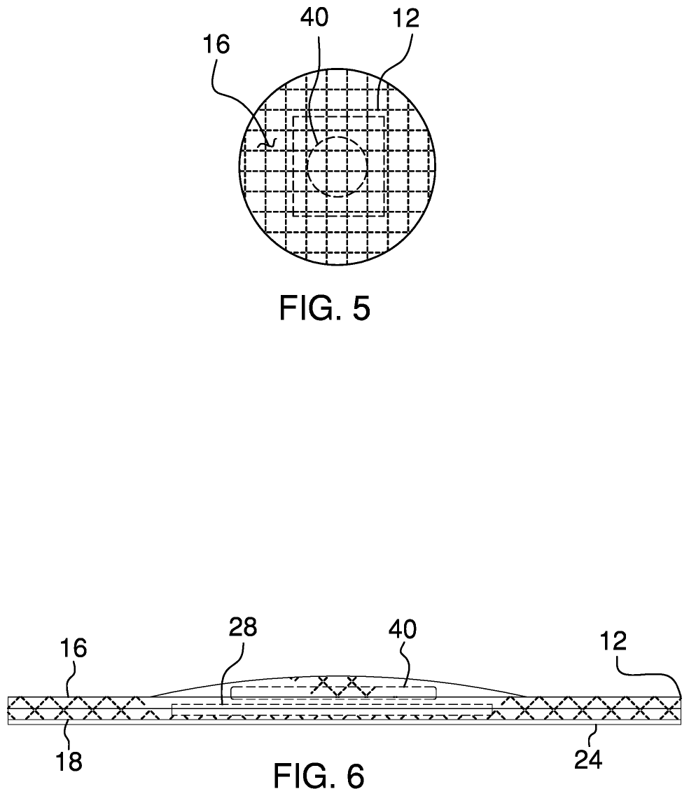

As best illustrated in FIGS. 1 through 9, the tracking bandage assembly 10 generally comprises a bandage 12 can be secured a user 14 to present the ornamental appearance of a dressing on a wound. The bandage 12 has a top surface 16 and a bottom surface 18, and the bandage 12 may have the color that matches the color of the user's skin. As is shown in FIGS. 1 through 4, the bandage 12 may be elongated to have the appearance of a Band-Aid® brand adhesive bandage or other bandage with a similar appearance. As is shown in FIGS. 5 through 7, the bandage 12 may be circular. A pad 20 is coupled to the bandage 12 and the pad 20 has blood indicia 22 thereon. In this way the pad 20 presents the ornamental appearance of having dressed a wound. The pad 20 is positioned on the bottom surface 18 of the bandage 12 and the pad 20 is centrally positioned on the bottom surface 18.

An adhesive layer 24 is coupled to the bandage 12 to adhere to the user 14 for retaining the bandage 12 on the user 14. The adhesive layer 24 is positioned on the bottom surface 18 of the bandage 12. Additionally, the adhesive layer 24 may be comprised of a skin-safe adhesive to safely secure the bandage 12 on the user 14. Additionally, the adhesive layer 24 reduces the likelihood that the bandage 12 will be lost or discovered by an observer. A protective sheet 26 may be positioned over the adhesive layer 24 for protecting the adhesive layer 24 before the bandage 12 is worn on the user 14.

A tracking unit 28 is provided and the tracking unit 28 is integrated into the bandage 12. The tracking unit 28 is in electrical communication with a global positioning system 30 (gps) to establish the physical location of the bandage 12. Additionally, the tracking unit 28 is in electrical communication with an extrinsic communication network 32, such as a cellular phone network, the internet or any other electronic means of communication. In this way the tracking unit 28 can notify emergency responders, such as 911 responders, an authorized caregiver or any other emergency responder, of the physical location of the bandage 12. In this way the emergency responders can locate the user 14 in an emergency.

The tracking unit 28 comprises a control circuit 34 that is integrated into the bandage 12. The control circuit 34 receives an alert input. A transceiver 36 is integrated into the bandage 12 and the transceiver 36 is electrically coupled to the control circuit 34. The transceiver 36 is turned on when the control circuit 34 receives the alert input. Additionally, the transceiver 36 is in electrical communication with the gps 30 for receiving the physical location of the bandage 12 from the gps 30.

The transceiver 36 is in electrical communication with the extrinsic communication network 32 to communicate the physical location of the bandage 12 to emergency responders when the control circuit 34 receives the alert input. The transceiver 36 may comprise a radio frequency transceiver 36 or the like, and the transceiver 36 may employ a WPAN signal and Bluetooth communication protocols. As shown in FIG. 4, the extrinsic communication network 32 may include a personal electronic device 38, such as a smart phone or the like, that is carried by the authorized caregiver. In this way the authorized caregiver can use gps location software stored on the personal electronic device 38 to track the user 14.

The tracking unit 28 includes a button 40 that is integrated into the bandage 12. The button 40 is electrically coupled to the control circuit 34. Additionally, the control circuit 34 receives the alert input when the button 40 is depressed. The tracking unit 28 includes a power supply 42 that is integrated into the bandage 12. The power supply 42 is electrically coupled to the control circuit 34 and the power supply 42 comprises at least one battery 44. Additionally, the authorized caregiver can remotely actuate the tracking unit 28 with the personal electronic device 38 when the user 14 is disabled, a child or is otherwise unable to actuate the tracking unit 28 without assistance.

In use, the bandage 12 is secured on the user 14 in order to discretely position the tracking unit 28 on the user 14. In this way a potential assailant, or even a casual observer, is unlikely to discover that the user 14 is wearing the tracking unit 28. The user 14 depresses the button 40 when the user 14 finds themselves in distress for any reason. Thus, the transceiver 36 collects the location information from the gps 30 and relays the location information to the emergency responders. In this way the emergency responders can locate the user 14 to provide assistance. Additionally, the authorized caregiver can remotely actuate the tracking unit 28, with the personal electronic device 38, for contacting the emergency responders when the user 14 is not capable of depressing the button 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A tracking bandage assembly being configured to be secured to a user thereby facilitating the user to be electronically tracked, said assembly comprising:
a bandage being securable on a user wherein said bandage is configured to present the ornamental appearance of a dressing on a wound;
a pad being coupled to said bandage, said pad having blood indicia thereon wherein said pad is configured to present the ornamental appearance of having dressed a wound;
an adhesive layer being coupled to said bandage wherein said adhesive layer is configured to adhere to the user for securing said bandage to the user; and
a tracking unit being integrated into said bandage, said tracking unit being in electrical communication with a global positioning system (gps) wherein said tracking unit is configured to establish the physical location of said bandage, said tracking unit being in electrical communication with an extrinsic communication network wherein said tracking unit is configured to notify emergency responders of the physical location of said bandage thereby facilitating the user to be located in an emergency.

2. The assembly according to claim 1, wherein:
said bandage has a top surface and a bottom surface;
said pad is positioned on said bottom surface of said bandage, said pad being centrally positioned on said bottom surface; and
said adhesive layer is positioned on said bottom surface of said bandage.

3. The assembly according to claim 1, wherein said tracking unit comprises a control circuit being integrated into said bandage, said control circuit receiving an alert input.

4. The assembly according to claim 3, wherein said tracking unit comprises a transceiver being integrated into said bandage, said transceiver being electrically coupled to said control circuit, said transceiver being turned on when said control circuit receives said alert input, said transceiver being in electrical communication with the gps for receiving the physical location of said bandage from the gps, said transceiver being in electrical communication with the extrinsic communication network wherein said transceiver communicates the physical location of said bandage to emergency responders when said control circuit receives said alert input.

5. The assembly according to claim 4, wherein said tracking unit comprises a button being integrated into said bandage, said button being electrically coupled to said control circuit, said control circuit receiving said alert input when said button is depressed.

6. The assembly according to claim 5, wherein said tracking unit includes a power supply being integrated into said bandage, said power supply being electrically coupled to said control circuit, said power supply comprising at least one battery.

7. A tracking bandage assembly being configured to be secured to a user thereby facilitating the user to be electronically tracked, said assembly comprising:
a bandage being securable to a user wherein said bandage is configured to present the ornamental appearance of a dressing on a wound, said bandage having a top surface and a bottom surface;
a pad being coupled to said bandage, said pad having blood indicia thereon wherein said pad is configured to present the ornamental appearance of having dressed a wound, said pad being positioned on said bottom surface of said bandage, said pad being centrally positioned on said bottom surface;
an adhesive layer being coupled to said bandage wherein said adhesive layer is configured to adhere to the user for securing said bandage to the user, said adhesive layer being positioned on said bottom surface of said bandage; and
a tracking unit being integrated into said bandage, said tracking unit being in electrical communication with a global positioning system (gps) wherein said tracking unit is configured to establish the physical location of said bandage, said tracking unit being in electrical communication with an extrinsic communication network wherein said tracking unit is configured to notify emergency responders of the physical location of said bandage thereby facilitating the user to be located in an emergency, said tracking unit comprising:
a control circuit being integrated into said bandage, said control circuit receiving an alert input;
a transceiver being integrated into said bandage, said transceiver being electrically coupled to said control circuit, said transceiver being turned on when said control circuit receives said alert input, said transceiver being in electrical communication with the gps for receiving the physical location of said bandage from the gps, said transceiver being in electrical communication with the extrinsic communication network wherein said transceiver communicates the physical location of said bandage to emergency responders when said control circuit receives said alert input;
a button being integrated into said bandage, said button being electrically coupled to said control circuit, said control circuit receiving said alert input when said button is depressed; and
a power supply being integrated into said bandage, said power supply being electrically coupled to said control circuit, said power supply comprising at least one battery.
